(19) United States
(12) Patent Application Publication
(10) Pub. No.: US 2026/0252264 A1
(43) Pub. Date: Aug. 27, 2026

(54) SECURE VEHICULAR DATA STORAGE

(71) Applicant: Micron Technology, Inc., Boise, ID (US)

(72) Inventor: Olivier Duval, Hudson, NH (US)

(21) Appl. No.: 19/541,950

(22) Filed: Feb. 17, 2026

Related U.S. Application Data
(60) Provisional application No. 63/762,901, filed on Feb. 25, 2025.

(51) Int. Cl. G06F 3/06

(52) U.S. Cl. CPC G06F 3/0655; G06F 3/0622; G06F 3/0679

(57) ABSTRACT

A method can be performed using a memory device. The method can include receiving sensor data associated with a vehicle. The method can include writing first sensor data of a first type of sensor data to a first portion of a memory device. The method can include writing second sensor data of a second type of sensor data to a second portion of the memory device. The method can include modifying at least one of the first or second sensor data in response to receiving a signature produced with a cryptographic key.

### PRIORITY APPLICATION

This application claims the benefit of priority to U.S. Provisional Application Ser. No. 63/762,901, filed Feb. 25, 2025, which is incorporated herein by reference in its entirety.

### TECHNICAL FIELD

The present disclosure relates generally to semiconductor memory and methods, and more particularly, to apparatuses, systems, and methods for secure vehicular data storage in a memory system.

### BACKGROUND

Vehicles such as automobiles, cars, trucks, buses, etc., can include or use various sensors. Sensors, such as cameras, can be used to obtain information about an environment around a vehicle, or to receive data associated with operation of the vehicle. For example, vehicles may use light detection and ranging (LIDAR), vehicle-to-everything (V2X), RADAR, and/or SONAR detection techniques, among others, to obtain information about their surroundings. Further, parameters of the vehicle when in use can be sensed or recorded to provide forensic analysis of the operation of the vehicle during a specified period of time for subsequent analysis.

### BRIEF DESCRIPTION OF THE DRAWINGS

The present disclosure will be understood more fully from the detailed description given below and from the accompanying drawings of various embodiments of the disclosure.

FIG. 1 is a block diagram of an example vehicle, in accordance with an embodiment of the present disclosure.

FIG. 2 is a block diagram of an example manager computing device in accordance with an embodiment of the present disclosure.

FIG. 3 is an example of a system including a vehicle and a manager computing device in accordance with some embodiments of the present disclosure.

FIG. 4 is an example method of writing data to a non-volatile memory device using a data controller and a manager component in accordance with some embodiments of the present disclosure.

FIG. 5 is an example method of reading data to a non-volatile memory device using a data controller and a manager component in accordance with some embodiments of the present disclosure.

FIG. 6 is an example of a first method for secure vehicular data storage in accordance with embodiments of the present disclosure.

FIG. 7 is an example of a second method for secure vehicular data storage in accordance with embodiments of the present disclosure.

FIG. 8 is a block diagram of an example computer system in which or with which embodiments of the present disclosure may operate.

### DETAILED DESCRIPTION

Secure vehicular data storage is described herein. An example apparatus for secure vehicular data storage can include a processor and a data controller. The data controller can be coupled to the processor and can be configured to receive sensor data from a vehicle and send a received first sensor data to a memory device (e.g., a non-volatile memory (NVM) device) to be written to a first portion of the memory device and send a received second sensor data to the memory device to be written to a second portion of the memory device. Each of the first portion and the second sensor data can be written to the memory device with or without a cryptographic key (or respective cryptographic keys) accompanying the command(s) to write the first or second sensor data. In this way, non-privileged programs or devices may be able to write to the memory device. However, after the first or second sensor data is written to the memory device, only privileged programs or devices, such as those owning a cryptographic key, can modify (e.g., change, expunge, replace, delete, etc.) or verify the written sensor data. The data controller can collect sensor data and package logs or combinations of the sensor data together according to one or more regulatory automotive forensic log data requirements or regulations.

The first sensor data can include event data recorder (EDR) data. As used herein, EDR data refers to data collected by an event data recorder (EDR) device. An EDR device can be installed in vehicles that record information related to vehicle crashes or accidents, among other vehicle data. EDR data can be used to capture and record data about the vehicle's performance and a driver's actions before, during and after a crash or road incident. The EDR data can be used to understand the circumstances leading to or during an accident or road incident. EDR data can include vehicle speed, engine rotations per minute (RPM), brake usage, throttle position, airbag deployment times, seatbelt status, steering angles, impact force and direction, among other status information items. The EDR data can be used by accident investigators, insurance companies, and/or law enforcement to reconstruct accidents, determine fault, and/or improve vehicle safety designs. However, criminals could tamper with important EDR data, such as to commit insurance fraud or obfuscate evidence showing reckless driving. To help alleviate these data tampering concerns, the data can be protected or processed to ensure that the data is secure and accurate, as will be described herein below.

The second sensor data can be collected by data storage systems for automated driving (DSSAD) and can provide DDSAD data. DSSAD data, used in autonomous and semi-autonomous vehicles, can include data related to the vehicle's operations and driving environment. The data storage systems, especially in autonomous vehicles, can be designed to handle vast amounts of data generated by the vehicle's sensors, cameras, RADAR, LIDAR, and other components. Information from these systems can be used for real-time decision-making and long-term data analysis. The data storage systems can include information received from sensors and data sources such as cameras that capture visual data around the vehicle; Lidar that provides three-dimensional (3D) mapping by measuring the distance to objects; radar that detects objects and their speed, especially useful in poor visibility conditions; ultrasonic sensors used for short-range detection, such as in parking; global positioning systems (GPS) that provide location data; and inertial measurement units (IMUs) that measure acceleration and rotational rates, among other such sensors and data sources not listed herein. DDSAD data can be used to optimize driving routes, improve driving efficiency, enhance collision avoidance systems and other safety features, and monitor and manage multiple autonomous vehicles in real time. Further DDSAD data can be used to ensure that vehicles meet legal standards for data recording and storage, as will be further described herein.

As will be described herein, by introducing a secure form of communication for collecting, storing, and extracting sensor data, information related to nefarious activity or false data in relation to these vehicular entities can be rejected, avoided, discarded, etc. Cryptographic keys can be exchanged and used to modify or verify sensor data from the memory device. In this way, those without the cryptographic key are prevented from modifying stored sensor data and sensor data extracted from the memory device is ensured to be authentic and accurate.

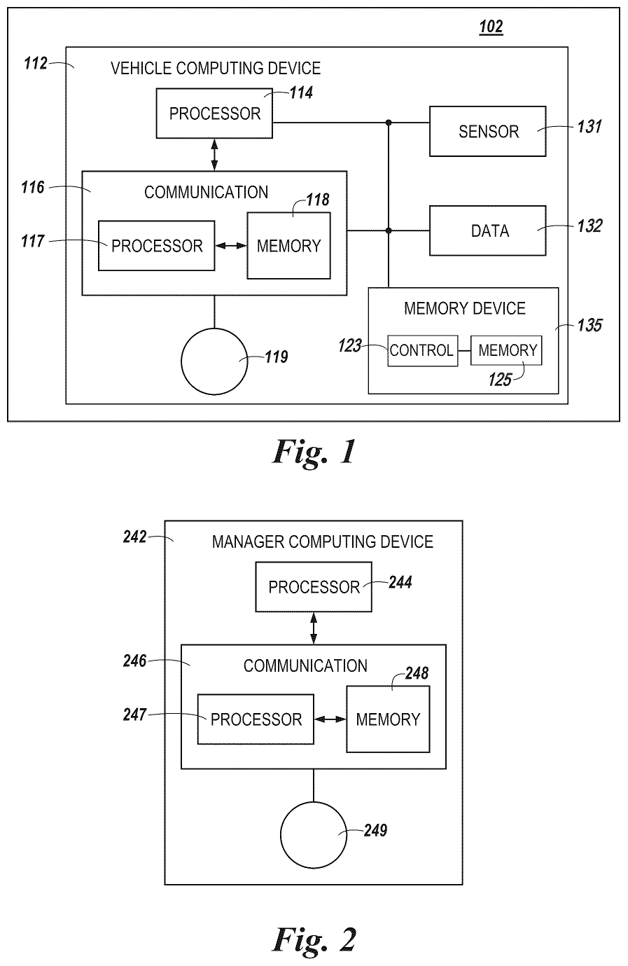

FIG. 1 is a block diagram of an example vehicle 102 in accordance with an embodiment of the present disclosure. The vehicle 102 can be an autonomous vehicle, a traditional non-autonomous vehicle, an emergency vehicle, a service vehicle, or the like. The vehicle 102 can include a vehicle computing device 112, such as an on-board computer. Vehicle computing device 112 can include a processor 114 coupled to a vehicular communication component 116, such as a reader, writer, and/or other computing device capable of performing the functions described below, that is coupled to (e.g., or includes) an antenna 119. The vehicle computing device 112 can include a sensor component 131 that includes sensors or is in communication with sensors of the vehicle 102. The sensors can include cameras, RADAR, LIDAR, and other components that gather data associated with the vehicle 102. The vehicle computing device 112 can include a data controller 132 and a memory device 135. The memory device 135 can be a non-volatile memory device (e.g., flash memory) or a volatile memory device. The memory device 135 can include control circuitry 123 and a memory array 125. The data controller 132 can be hardware, software, firmware, etc., used to write the sensor data to the memory device 135. The vehicular communication component 116 can include a processor 117 coupled to a memory 118, such as a non-volatile flash memory, although embodiments are not so limited.

The vehicle computing device 112 can control operational parameters of vehicle 102, such as sensor data collection and data storage in the memory device 135. For example, a controller (not shown) can be coupled to a system of sensors, the data controller 132, and the memory device 135 to coordinate data collection and storage in the vehicle computing device 112.

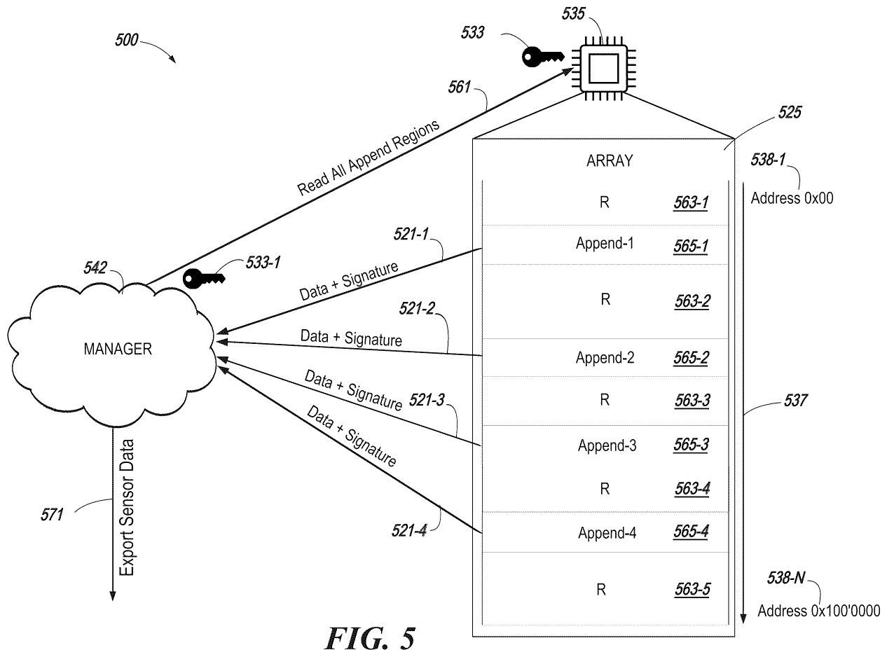

The vehicular communication component 116 can receive sensor and vehicular information from additional computing devices, such as from a manager computing device 242 described in association with FIG. 2. The processor 114 can cause the sensor component 131 to collect sensor data and/or data controller 132 to store the sensor data in the memory device 135, based on additional information received from the manager computing device 242. For example, the manager computing device 242 can indicate to the processor 114 to modify the sensor data stored the memory device 135, as will be further described in association with FIGS. 5-7 below.

FIG. 2 is a block diagram of an example manager computing device 242 in accordance with an embodiment of the present disclosure. The manager computing device 242 can include hardware, software, and/or firmware to communicate with the vehicle computing device 112. The manager computing device 242 can include a processor 244 coupled to a manager communication component 246, such as a reader, writer, and/or other computing device capable of performing the functions described below, that is coupled to (e.g., or includes) an antenna 249. The manager communication component 246 can include a processor 247 coupled to a memory 248, such as a non-volatile flash memory, although embodiments are not so limited. The antenna 249 of the manager computing device 242 can be in communication with the antenna 119 of the vehicle 102.

In some examples, antennas 249 and 119 can be loop antennas configured as inductor coils, such as solenoids. The antenna 119 can loop around the vehicle 102, for example. The antenna 119 can generate an electromagnetic field in response to current flowing through the antenna 119. For example, the strength of the electromagnetic field can depend on the number of coils and the amount of current. The electromagnetic field generated by the antenna 119 can induce current flow in an antenna 249 that powers the respective external computing device 242. As an example, the antenna 119 in FIG. 1 can induce current flow in the antenna 249 when the vehicle 102 brings the antenna 119 to within a communication distance (e.g., a communication range) of the antenna 249. For example, the communication distance can depend on the strength of the electromagnetic field generated by the antenna 119. The electromagnetic field generated by the antenna 119 can be a function of the number of coils of the antenna 119 and/or the current passing through the antenna 119, such that the communication distance can span the left and right lanes of a road. In some examples, the communication distance can be about 50 centimeters to about 100 centimeters on either side of the vehicle 102.

In some examples, the manager computing device 242 can include one or more wireless communication devices, such as transmitters, transponders, transceivers, or the like. As an example, the manager communication component 246 can be such a wireless communication device. In some examples, wireless communication devices can be passive wireless communication devices that are powered (e.g., energized) by the vehicle 102, as described above. Wireless communication devices can be located along a route, such as a road, on which the vehicle 102 can travel. In some examples, the route can include a number of roads. Wireless communication devices can transmit management information to the vehicle computing device 112 in response to receiving a request for sensor data associated with the vehicle 102. Wireless communication devices can be short-range wireless communication devices, such as near field communication (NFC) tags, RFID tags, or the like. In at least one embodiment, wireless communication devices can include non-volatile storage components that can be respectively integrated into chips, such as microchips. Each of the respective chips can be coupled to a respective antenna 249. The respective storage components can store respective route information.

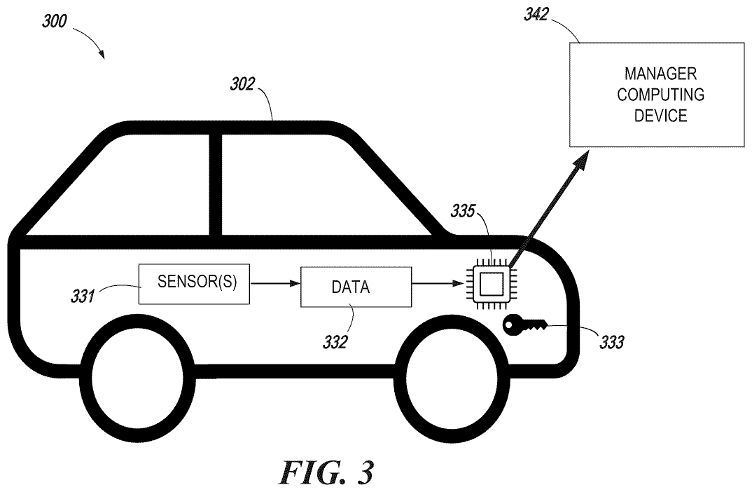

FIG. 3 is an example of a system 300 including a vehicle 302 and a manager computing device 342 in accordance with some embodiments of the present disclosure. The vehicle 302 can includes sensor(s) 331, a data controller 332, and a memory device 335. The sensor(s) 331 can comprise an example of the sensor component 131 in FIG. 1 or can be in communication with the sensor component 131 to transfer the sensor data to the data controller 332. The data controller 332 can be similar to data controller 132 in FIG. 1. The data controller 332 can be hardware, software, and/or firmware used to process the sensor data and to coordinate storage of the sensor data in the memory device 335. The memory device 335 can be similar to memory device 135 in FIG. 1 and can include a non-volatile memory device (e.g., a flash memory device) or a volatile memory device.

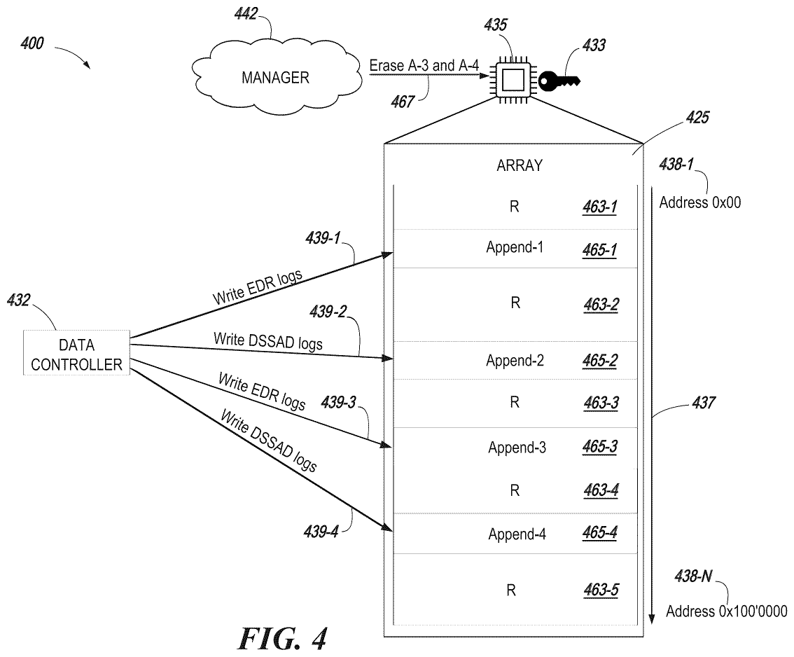

As will be further described in association with FIGS. 4-5, the sensor(s) can collect and transfer sensor data to the data controller 332. The data controllers 332 can package, collate, or combine sensor data together (e.g., first sensor data and second sensor data) in order to send to the memory device 335. The data controller 332 can package, collate, or combine sensor data to create logs or packages of sensor data that can be stored in the memory device 335 for subsequent access, as is described herein. The data controller 332 can write the sensor data to a plurality of portions of an array of the memory device 335. For example, the data controller 332 can transfer a first type of sensor data, such as EDR data, to a first portion of the array of the memory device 335. The data controller 332 can transfer a second type of sensor data, such as DSSAD data, to a second portion of the array of the memory device 335. The data controller 332 can write the sensor data to the memory device 335 without providing a cryptographic key or other security type verification. However, to maintain the integrity of the stored data in the data controller 332, a cryptographic key or other authentication mechanism can be required to modify or delete the sensor data from the memory device 335.

The manager computing device 342, similar to manager computing device 142 in FIG. 1, can send commands to the memory device 335 to indicate to the modify or delete portions of the sensor data stored in the memory device 335. The sensor data can be modified or deleted in response to the commands. In an example, the sensor data can be modified or deleted according to a schedule or at specified time intervals provided by the manager computing device 342.

FIG. 4 is an example that includes writing data to a memory device using a data controller 432 and a manager component 442 in accordance with some embodiments of the present disclosure. The data controller 432 and the manager component 442 are similar to data controller 332 and manager computing device 342 in FIG. 3, respectively. The manager component 442 may be a computing device as shown in FIG. 3 or part of a manager cloud system that is in communication with the memory device 435 and/or the data controller 432. The data controller 432 can write sensor data to the memory device 435, as illustrated in FIG. 4.

The memory device 435 can include an array 425 that includes a plurality of addresses 438-1 (e.g., “Address 0x00”) to 438-N (e.g., “Address 0x100′0000”). The array 425 can store a number of portions of regular data (“R”) 463-1, 463-2, 463-3, 463-4, 463-5 (hereinafter referred to collectively as regular data 463). Regular data 463 can refer to data that is not sensor data and/or data that is not used for writing data of a particular designated data type, such as EDR or DSSAD data. The data controller 432 can receive sensor data from sensor(s) or a sensor component (e.g., sensor component 131 or sensor(s) 331). The manager component 442 can send commands to designate specified portions of the memory array 425 for storing data (e.g., sensor data) in an appendable mode in those specified portions. For example, a portion of the addresses 438 can be designated as a first appendable region (“Append-1”) 465-1 such that particular data (e.g., EDR data) is stored in the first appendable region 465-1. The address values or ranges that each appendable region is designated may be adjusted by the manager component 442. In an example, after the regions are set, the appendable region can first be written into without a cryptographic key and cannot later be modified without the cryptographic key.

The data controller 432 can cause writing of first sensor data of a first type of data, such as EDR data, to a first portion of the memory array 425. The first sensor data can be written in a secure append write mode. The secure append write mode can include writing data into a particular region of the memory array 425 that is designated as an appendable region, and optionally that requires a secret or cryptographic key to verify or modify the data in the appendable region. For example, at arrow 439-1, the data controller 432 writes EDR logs (“Write EDR logs”) to a first appendable memory portion (e.g., “Append-1”) 465-1. The first sensor data written at arrow 439-1 can be referred to as a first portion of the first sensor data. The data controller 432 can cause writing of second sensor data of a second type of sensor data, such as DSSAD data. The second sensor data can be written in a secure append write mode. For example, at arrow 439-2, the data controller 432 writes DSSAD (“Write DSSAD logs”) to a second appendable memory portion (e.g., “Append-2”) 465-2. The second sensor data written at arrow 439-2 can be referred to as a first portion of the second sensor data. The data controller 432 can cause writing of a second portion of first sensor data, such as EDR data, to a third portion of the memory array 425. For example, at arrow 439-3, the data controller 432 writes EDR logs (“Write EDR logs”) to a third appendable memory portion (e.g., “Append-3”) 465-3. The data controller 432 can cause writing of a second portion of second sensor data, such as DSSAD data. For example, at arrow 439-4, the data controller 432 writes DSSAD (“Write DSSAD logs”) to a fourth appendable memory portion (e.g., “Append-4”) 465-4. In this way, one or more appendable regions of the memory array 425 (e.g., 465-1 and 465-3) can store first sensor data (e.g., EDR data) and one or more other appendable regions of the memory array 425 (e.g., 465-2 and 465-4) can store second sensor data (e.g., DSSAD data).

The manager component can coordinate erasure of outdated sensor data by sending a command to erase at least a portion of the sensor data stored in an appendable region 465. The command can use, or require the knowledge of, a cryptographic key 433. A cryptographic key can be used to generate a signature, transferred as a parameter used in cryptographic sequences to encrypt and decrypt data. The cryptographic key is kept confidential to ensure the security of the operations. Cryptography can use a symmetric cryptographic key or an asymmetric cryptographic key pair. Symmetric cryptography uses the same cryptographic key for both encryption and decryption. Examples include AES (Advanced Encryption Standard) and DES (Data Encryption Standard). Asymmetric cryptography uses a pair of keys, one public and one private (secret). The private key is kept secret, while the public key can be shared openly. Examples include RSA (Rivest-Shamir-Adleman) and ECC (Elliptic Curve Cryptography). Use of cryptographic keys can help one entity receiving a message through a non-secure channel to ensure that it was transmitted by a trusted second entity and not modified by a third party. Cryptographic keys can be used to generate digital signatures to verify the authenticity and integrity of a message or document. The sender signs with their private key, and the receiver verifies with the sender's public key. A cryptographic key can be used for authentication by confirming the identity of a user or device, ensuring that only authorized entities can access certain information or systems. Cryptographic keys can be generated using secure methods to ensure they are random and difficult to predict. Cryptographic keys can be stored securely, often in hardware security modules (HSMs) or using encryption. In this way, the cryptographic key 433 can be used to ensure that the sensor data stored in the array 425, e.g., EDR data and DSSAD data, is authentic and has not been tampered with or changed without authorization.

The manager component 442 can cause a portion of the stored sensor data to be erased at specified time intervals. For example, the manager component 442 can send a command to erase data stored in one or more of the illustrated appendable regions, and the data can be of the same or a different type. For example, at a first time, the manager component 442 can send a command to erase the third and fourth appendable regions 465-3, 465-4 in order to erase one set of the EDR data (stored in appendable region 465-3) and one set of the DSSAD data (stored in appendable region 465-4). In this way, a different set of the EDR data and a different set of the DSSAD data is still preserved in the other two appendable regions, e.g., 465-1, 465-2, respectively. At a later second time, the first and second appendable regions 465-1, 465-2 can be erased and so forth in a rotating cycle to erase data of at least two different data types, while preserving data of at least two different sensor data types in the memory array 425.

FIG. 5 is an example that includes reading data to a non-volatile memory device using a manager component 542 in accordance with some embodiments of the present disclosure. The manager component 542 is similar to the manager computing device 342 in FIG. 3 and the manager component 442 in FIG. 4. The manager component 542 may be a computing device as shown in FIG. 3 or part of a manager cloud system that is in communication with the memory device 535.

The memory device 535 can include an array 525 that includes a plurality of addresses 538-1 (e.g., “Address 0x00”) to 538-N (e.g., “Address ox100′0000”). The array 525 can store a number of portions of regular data (“R”) 563-1, 563-2, 563-3, 563-4, 563-5 (hereinafter referred to collectively as regular data 563). Regular data 563 can refer to data that is not sensor data and/or data that is not used for writing EDR or DSSAD data. The data controller 532 can receive sensor data from sensor(s) or a sensor component (e.g., sensor(s) 331 or sensor component 131). The manager component 542 can send commands to designate specified portions of the memory array 525 for storing data (e.g., sensor data) in an appendable mode in those specified portions. For example, a portion of the addresses 538 can be designated as a first appendable region (“Append-1”) 565-1 such that EDR data is stored in the first appendable region 565-1. The address values or ranges that each appendable region is designated may be adjusted by the manager component 542 but, once set, the appendable region can only be written to without a cryptographic key and cannot be modified without providing the cryptographic key 533.

The manager component 542 can send a command 561 to “Read ALL Append Regions” (as illustrated by an arrow extending from the manager component 542) to the memory device 535. In response to receiving the command 561, the memory device 535 can read out the sensor data from the appendable regions, e.g., read out sensor data (e.g., “Data”) from the appendable regions 565-1, 565-2, 565-3, 565-4, and generate a corresponding signature (e.g., “Signature”) to verify that the sensor data is authentic or not modified without authorization. The signature can be generated using the cryptographic key 533. The sensor data can then be sent to an external device or external entity that is requesting the sensor data through messages 521-1, 521-2, 521-3 and 521-4. The manager component 542 can then verify the authenticity of the data using its cryptographic key 533-1. For example, in response to an accident, a regulatory body or agency may request the sensor data to determine what happened in the accident and the sensor data can be verified and exported to the regulatory body or agency.

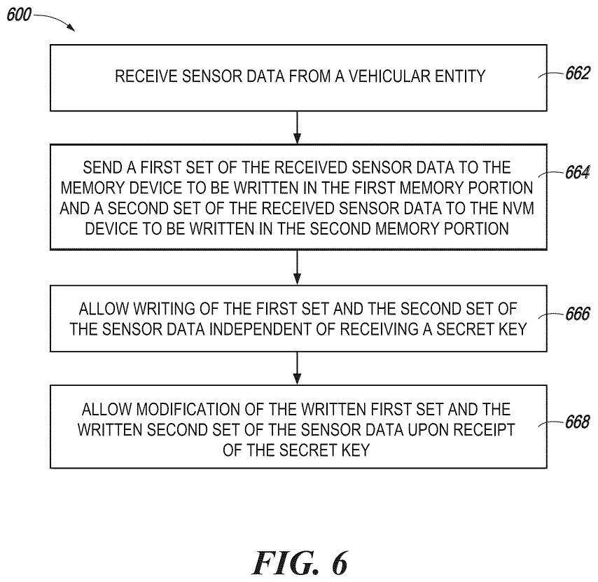

FIG. 6 is an example of a first method 600 for secure vehicular data storage in accordance with embodiments of the present disclosure. The first method 600 can be performed using the memory device 135, 335 illustrated in FIGS. 1 and 3. The first method 600 can be performed by processing logic that can include hardware (e.g., a processing device, circuitry, dedicated logic, programmable logic, microcode, hardware of a device, integrated circuit, etc.), software (e.g., instructions run or executed on a processing device), or a combination thereof. In some embodiments, the first method 600 is performed by the processor 114 in coordination with the sensor component 131, and the data controller 132 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 662, the first method 600 can include receiving, at a data controller, sensor data from a vehicle. In some examples, the data controller can compile the received sensor data into logs or aggregate data, according to one or more regulatory automotive forensic log data standards.

At block 664, the first method 600 can include sending a first portion of the received sensor data to the memory device to be written in the first memory portion and a second portion of the received sensor data to the memory device to be written in the second memory portion. The first portion of the sensor data is event data recorder (EDR) data and the second portion of the sensor data is data storage system for automated drive (DSSAD) data.

At block 666, the first method 600 can include allowing, by the memory device or a controller or processor of the memory device, writing of the first portion and the second portion of the sensor data independent of receiving a cryptographic key. For example, the secret key may not be provided with the request to write the sensor data to the memory device. In an example, the memory device writes the sensor data even though modification of the sensor data, once written, requires a cryptographic key to be modified or erased.

At block 668, the first method 600 can include allowing, by the memory device or a controller or processor of the memory device, modification of the written first portion and the written second portion of the sensor data upon receipt and validation of the signature or cryptographic key. In some examples, the data controller can be prevented from modifying the first portion and/or the second portion of the received sensor data after the first portion and the second portion are written to the memory device. In some examples, the processor of a vehicular computing device is configured to receive a command from an external component that includes the cryptographic key and the command indicates to cause modification of at least some of the sensor data that is written to the memory device.

In some examples, the memory device can include a third portion and the third portion is configured to store data not associated with the sensors of the vehicle. In some examples, the first method 600 can include sending, via a manager component, a command and the cryptographic key to the non-volatile memory device, wherein the command indicates to modify at least a portion of the first portion or the second portion of the sensor data. The manager component can erase or delete the at least a portion of the first portion or the second portion of the sensor data in response to the at least a portion reaching a threshold period of time, or a duration, of storage associated with an expiration of the at least a portion. The manager component can send a command and the cryptographic key to the memory device, such as a non-volatile memory device (NVM device), the command requesting to read each of the first portion and the second portion of the sensor data stored in the NVM device. The NVM device, or a controller or processor of the NVM device, can send the requested first portion and the requested second portion of the sensor data and a signature associated with each of the first portion and the second portion to the manager component in response to receiving the command. The manager component can verify the signatures to authenticate the first portion and the second portion of the sensor data. The manager component can, in response to successfully authenticating the first portion and the second portion of the sensor data, send the first portion and the second portion of the sensor data to an external device.

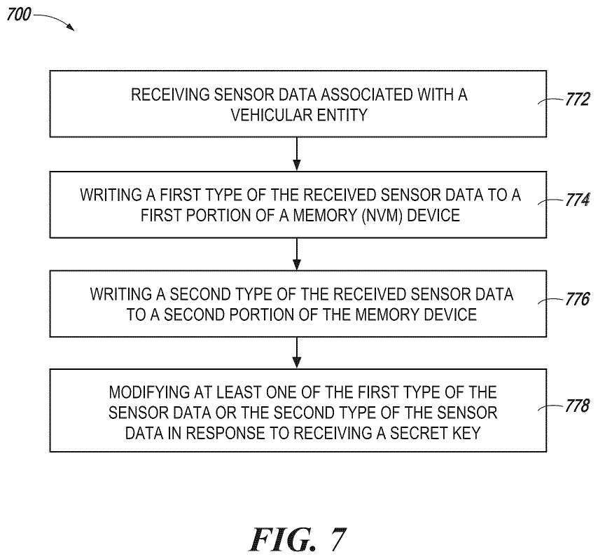

FIG. 7 is an example of a second method 700 for secure vehicular data storage in accordance with embodiments of the present disclosure. The second method 700 can be performed using the memory device 135, 335 illustrated in FIGS. 1 and 3. The second method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the second method 700 is performed by the processor 114 in coordination with the sensor component 131, and the data controller 132 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 772, the second method 700 can include receiving sensor data associated with a vehicle. At block 774, the second method 700 can include writing a first type of the received sensor data to a first portion of a memory device. The writing of the first type of the received sensor data can be performed independent of receiving the cryptographic key.

At block 776, the second method 700 can include writing a second type of the received sensor data to a second portion of the memory device. The writing of the second type of the received sensor data can be performed independent of receiving the cryptographic key. In some embodiments, the second method 700 can include writing a first portion of the first type of the received sensor data and a first portion of the second type of the received sensor data during a first time period. In some embodiments, the second method 700 can include writing a second portion of the first type of the received sensor data and a second portion of the second type of the received sensor data during a second time period. In some embodiments, the second method 700 can include deleting the second portion of the first type and the second portion of the second type of the sensor data during a fourth time period subsequent to the third time period. The first portion of the first type and the first portion of the second type of the sensor data can be deleted in response to the first portion of the first type and the first portion of the second type of sensor data reaching a threshold expiration duration or time point.

At block 778, the second method 700 can include modifying (e.g., deleting) at least one of the first type of the sensor data or the second type of the sensor data in response to receiving a cryptographic key. In some embodiments, the second method 700 can include deleting the first portion of the first type and the first portion of the second type of the sensor data during a third time period subsequent to the second time period.

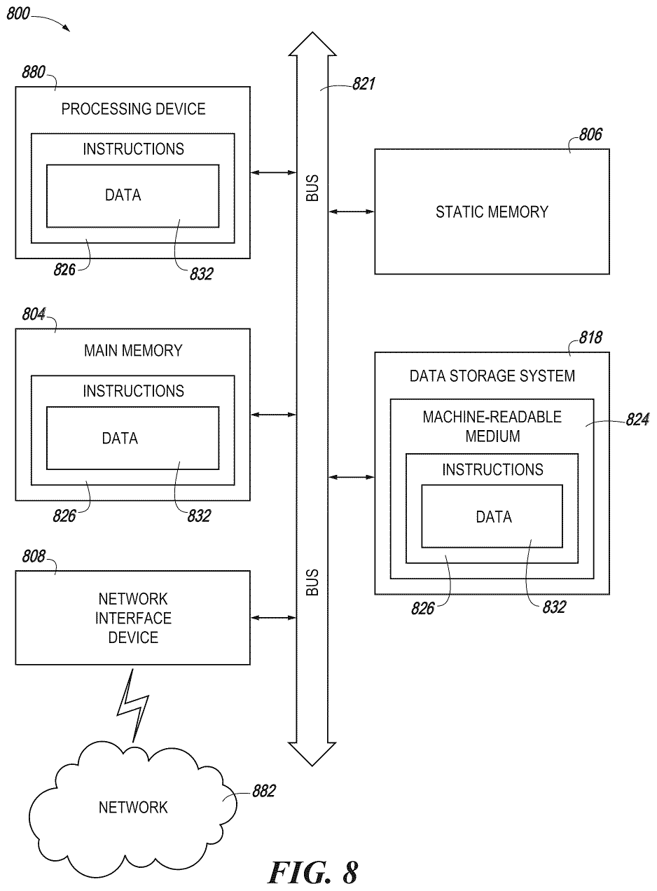

FIG. 8 is a block diagram of an example computer system 800 in which embodiments of the present disclosure may operate. For example, FIG. 8 illustrates an example machine of a computer system 800 within which a set of instructions, for causing the machine to perform any one or more of the methodologies discussed herein, can be executed. In some embodiments, the computer system 800 can correspond to a host system (e.g., the host system 120 of FIG. 1) that includes, is coupled to, or utilizes a memory system (e.g., the memory system 110 of FIG. 1) or can be used to perform the operations of a controller (e.g., to execute an operating system to perform operations corresponding to the refresh manager 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 880, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage system 818, which communicate with each other via a bus 821.

The processing device 880 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 880 can also be one or more special-purpose processing devices such as an application specific integrated circuit (ASIC), a field programmable gate array (FPGA), a digital signal processor (DSP), network processor, or the like. The processing device 880 is configured to execute instructions 826 for performing the operations and steps discussed herein. The computer system 800 can further include a network interface device 808 to communicate over the network 882. The network 882 can include a manager component, such as manager component 442 in FIG. 4.

The data storage system 818 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 880 during execution thereof by the computer system 800, the main memory 804 and the processing device 880 also constituting machine-readable storage media. The machine-readable storage medium 824, data storage system 818, and/or main memory 804 can correspond to the memory system 110 of FIG. 1.

In one embodiment, the instructions 826 include instructions to implement functionality corresponding to a data controller 832 (e.g., the data controller 132 of FIG. 1). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus comprising:
a memory device comprising a first memory portion and a second memory portion; and
a data controller in communication with the memory device, wherein the data controller is configured to:
receive first and second sensor data from a vehicle; and
send the first and second sensor data together to the memory device, wherein the first sensor data is to be written in the first memory portion and the second sensor is to be written in the second memory portion;
wherein the memory device is configured to:
allow writing of the first sensor data to the first memory portion and allow writing of the second sensor data to the second memory portion; and
conditionally allow modification of the written first sensor data and the written second sensor data based on receipt of a command produced at least in part using a particular cryptographic key.

2. The apparatus of claim 1, wherein the memory device is configured to allow the writing of the first and second sensor data using a secure append write mode.

3. The apparatus of claim 2, wherein the first and second portions of the memory device are physically non-adjacent portions and/or correspond to non-adjacent addresses in the memory device.

4. The apparatus of claim 1, wherein the memory device is configured to prevent modification of the first and second sensor data after the first and second sensor data are written to the memory device.

5. The apparatus of claim 1, wherein the data controller is configured to compile the received first and second sensor data according to one or more regulatory automotive forensic log data standards.

6. The apparatus of claim 1, wherein the first sensor data is event data recorder (EDR) data and the second sensor data is data storage system for automated drive (DSSAD) data.

7. The apparatus of claim 1, wherein the first sensor data and the second sensor data are received from the same vehicle sensor.

8. The apparatus of claim 1, wherein the memory device is configured to receive a command from an external component, wherein the command includes the cryptographic key and indicates modification of, or access to, at least one of the first and second sensor data stored by the memory device.

9. The apparatus of claim 1, wherein:
the memory device comprises a third portion; and
the third portion is configured to store vehicle data that is other than data associated with the sensors of the vehicle.

10. A method, comprising:
receiving first and second sensor data associated with a vehicle;
using a secure append write mode, writing the first sensor data to a first portion of a memory device and writing the second sensor data to a second portion of the memory device; and
conditionally modifying at least one of the first and second sensor data in response to receipt of a command that includes a signature generated using a particular cryptographic key.

11. The method of claim 10, wherein the writing the first sensor data is performed independent of receiving the signature generated using the cryptographic key.

12. The method of claim 10, wherein the writing the second sensor data is performed independent of receiving the signature generated using the cryptographic key.

13. The method of claim 10, comprising writing a first portion of the first sensor data during a first time period and writing a first portion of the second sensor data during the first time period.

14. The method of claim 13, comprising writing a second portion of the first sensor data during a second time period and writing a second portion of the second sensor data during the second time period.

15. The method of claim 14, comprising, upon expiration of a specified time limit, updating or deleting the first portion of the first sensor data and the first portion of the second sensor data during a third time period subsequent to the second time period.

16. A system, comprising:
a non-volatile memory (NVM) device comprising a first memory portion and a second memory portion, wherein the NVM device is configured to write first sensor data to a first portion of the NVM device and write second sensor data to a second portion of the NVM device;
a data controller in communication with the NVM device and comprising a data processor and data memory, wherein the data controller is configured to:
receive the first and second sensor data, wherein the first and second sensor data are received from one or more vehicle sensors; and
send the first and second sensor data together to the NVM device; and
a manager component in communication with the NVM device and the data controller, the manager component configured to:
send a command to the NVM device, wherein the command is signed with a signature using a cryptographic key and the command indicates to modify at least a portion of the first sensor data stored in the first portion of the NVM device;
wherein the NVM device is configured to allow access to the first portion of the NVM device upon validation of the signature.

17. The system of claim 16, wherein upon expiration of a specified threshold storage duration, the manager component is configured to expunge or replace the first sensor data in the first portion of the NVM device.

18. The system of claim 16, wherein:
the manager component is configured to send a read command and the cryptographic key to the NVM device;
the read command includes a request to read each of the first and second sensor data stored in the NVM device; and
the NVM device is configured to send the requested first and second sensor data and a corresponding signature to the manager component in response to receiving the command.

19. The system of claim 18, wherein the manager component is configured to use the signature to authenticate the first and second sensor data.

20. The system of claim 19, wherein the manager component is configured to, in response to successfully authenticating the sensor data, send the first and the second sensor data to an external device.
